(19) United States
(12) Patent Application Publication
(10) Pub. No.: US 2011/0252074 A1
(43) Pub. Date: Oct. 13, 2011

(54) RESOURCE DATA MANAGEMENT APPARATUS AND RESOURCE DATA MANAGEMENT METHOD

(75) Inventors: Hitomi FUJITA, Matsumoto-shi (JP); Satoshi KOTAKA, Azumino-shi (JP); Atsushi FUJIMAKI, Shiojiri-shi (JP)

(73) Assignee: SEIKO EPSON CORPORATION, Tokyo (JP)

(21) Appl. No.: 13/084,384

(22) Filed: Apr. 11, 2011

(30) Foreign Application Priority Data
Apr. 12, 2010 (JP) 2010-091501

(51) Int. Cl. G06F 17/30

(52) U.S. Cl. 707/812; 707/E17.044

(57) ABSTRACT

A resource data management apparatus includes: at least one resource data package that is associated with a package ID and that stores a resource data set, the resource data set serving as a unit of management; a config data table that stores location information of each resource data package; and a resource data table creation unit that creates a resource data table storing the package ID and the location information of the resource data package, by referring to the resource data package and the config data table.

### BACKGROUND

1. Technical Field

The present invention relates to resource data management apparatuses and resource data management methods.

2. Related Art

Thus far, in image forming apparatuses such as printers, a single language for natural language messages displayed in display panels such as operation units has been selected from among multiple languages to accommodate users from various countries, and the messages are then displayed in that language.

JP-A-2006-293585 discloses a method in which a message table holding menu items in association with message data in various languages is prepared in advance, and message data corresponding to a menu item and a language specified through user input is obtained, and then used in a display or the like, by referring to the stated message table.

However, the technique disclosed in JPA-2006-293585 has a problem in that when the message data is to be updated by, for example, replacing the message data of a given language that corresponds to a single menu item, adding message data corresponding to the various menu items for a new language, or the like, it is necessary for the designer of the message table to re-create the message table and replace the existing message table, which requires effort and incurs costs.

### SUMMARY

An advantage of some aspects of the invention is to provide a novel resource data management apparatus that eliminates the effort and cost involved when a designer resets resource data such as message data when the resource data is to be updated, and that enables the resource data to be updated in a flexible manner.

A resource data management apparatus according to an aspect of the invention includes: at least one resource data package that is associated with a package ID and that stores a resource data set, the resource data set serving as a unit of management; a config data table that stores location information of each resource data package; and a resource data table creation unit that creates a resource data table storing the package ID and the location information of the resource data package, by referring to the resource data package and the config data table.

In a resource data management apparatus according to another aspect of the invention, it is preferable for the resource data set to include one or more data IDs and real data corresponding to the one or more data IDs.

Furthermore, it is preferable for a resource data management apparatus according to another aspect of the invention to further include: a receiving unit that receives a specific package ID and a specific data ID; a first obtainment unit that obtains location information of a resource data package corresponding to the specific package ID by referring to the created resource data table; a second obtainment unit that obtains real data corresponding to the specific data ID by referring to the resource data package corresponding to the specific package ID based on the obtained location information of the resource data package; and a display unit that displays the obtained real data.

Furthermore, in a resource data management apparatus according to another aspect of the invention, it is preferable for the resource data set to further include location information within a package of real data associated with the data ID; and the second obtainment unit to obtain real data corresponding to the location information within the package of the real data associated with the specific data ID by referring to the resource data package corresponding to the specific package ID based on the obtained location information of the resource data package.

Furthermore, in a resource data management apparatus according to another aspect of the invention, it is preferable for the resource data table creation unit to create the resource data table when the receiving unit has received the specific package ID and the specific data ID, when the resource data package has been updated, or when the apparatus has been turned on.

Furthermore, in a resource data management apparatus according to another aspect of the invention, it is preferable for the resource data package to include one or more data IDs and location information of real data associated with the one or more data IDs, and to furthermore store a second type resource data in which at least one piece of location information from among the pieces of location information of the real data associated with the one or more data IDs indicates location information of real data included in another resource data package.

Furthermore, in a resource data management apparatus according to another aspect of the invention, it is preferable for the resource data package to be stored in a storage device installed in the apparatus itself or in a storage medium that can be attached to/removed from the apparatus itself.

Furthermore, in a resource data management apparatus according to another aspect of the invention, it is preferable for the resource data set to be configured of at least one of a character string data set, a font data set, an icon data set, and a help guidance data set used in an image forming apparatus.

A resource data management method according to another aspect of the invention includes: storing at least one resource data package that holds a resource data set serving as a unit of management in association with a package ID, and a config data table that holds location information of each of the resource data packages; and creating a resource data table storing the package ID and the location information of the resource data package by referring to the resource data package and the config data table.

### BRIEF DESCRIPTION OF THE DRAWINGS

The invention will be described with reference to the accompanying drawings, wherein like numbers reference like elements.

FIG. 1 is a block diagram illustrating the hardware configuration of a printer apparatus according to an embodiment of the invention.

FIG. 2 is a diagram illustrating an example of the overall configuration of a printer apparatus according to an embodiment of the invention.

FIG. 3 is a diagram illustrating an example of the data structure of config data.

FIGS. 4A and 4B are diagrams illustrating examples of package location information and path information.

FIG. 5 is a diagram illustrating an example of the data structure of resource data.

FIG. 6 is a diagram illustrating an example of character string data.

FIG. 7 is a diagram illustrating an example of a resource data table.

FIG. 8 is a flowchart illustrating the details of processing performed in a resource data management method according to an embodiment of the invention.

FIG. 9 is a diagram illustrating an example of the data structures of first resource data and second resource data.

FIG. 10 is a diagram illustrating an example of the overall configuration of a printer apparatus according to a variation on an embodiment of the invention.

### DESCRIPTION OF EXEMPLARY EMBODIMENTS

An embodiment for implementing the invention will be described hereinafter with reference to the drawings. Note that in this embodiment, a printer apparatus will be described as an example of a resource data management apparatus. Furthermore, data regarding character strings (character string data) displayed in an operation panel or the like of the printer apparatus will be described as an example of resource data.

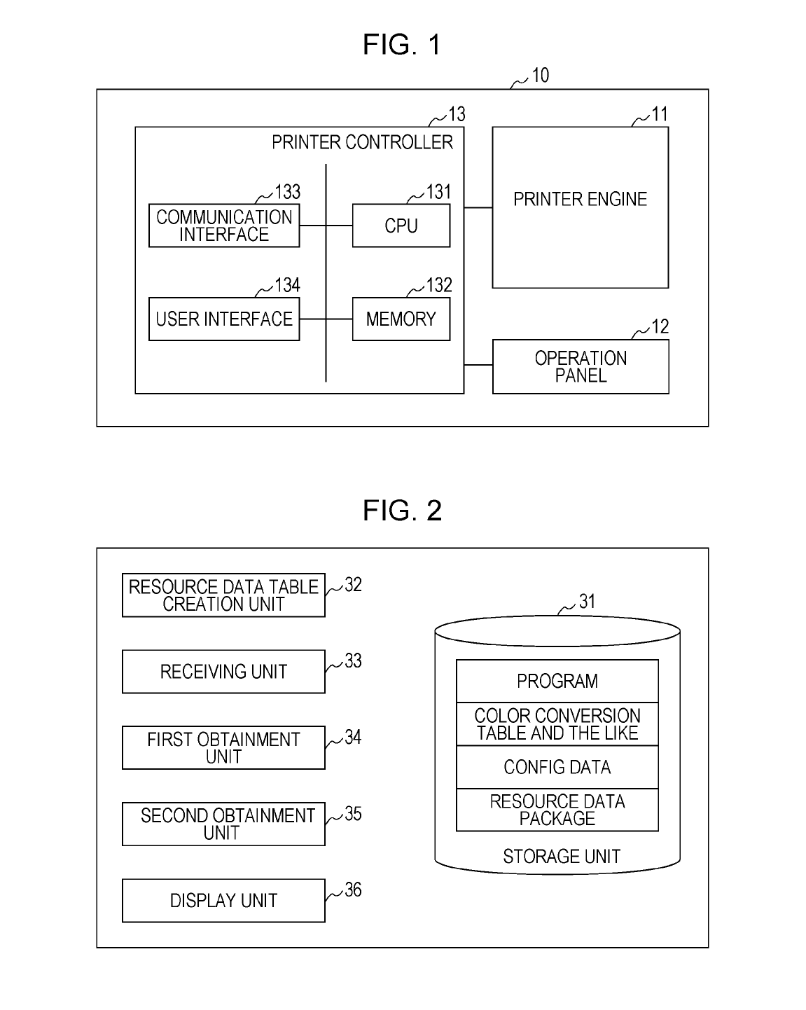

FIG. 1 is a block diagram illustrating the hardware configuration of a printer apparatus 10 according to this embodiment.

As shown in FIG. 1, the printer apparatus 10 includes a printer engine 11, an operation panel 12, and a printer controller 13 or the like. However, it should be noted that the operation panel 12 or the printer controller 13 may be implemented as units that are separate from the printer apparatus 10.

The printer engine 11 receives print data and executes a printing process. The printer engine 11 can be implemented using the same functional configuration as the printer engine in a typical printer apparatus such as an ink jet printer, a laser printer, or the like, and thus detailed descriptions thereof will be omitted here.

The operation panel 12 is an input unit for inputting instructions from a user, and is configured of a liquid-crystal display, operation buttons, and so on. With the operation panel 12, the user can select a single language from multiple languages by, for example, manipulating the operation buttons; furthermore, various types of messages relating to printer processes can be displayed in the selected language. Note that as a general rule, the operation panel 12 itself can be provided with the same functional configuration as that of operation panels used in past printers.

The printer controller 13 executes various processes for the printer apparatus 10 as a whole, and includes a CPU 131, a memory (storage device) 132, a communication interface 133, a user interface 134, and so on. The CPU 131 reads out computer programs stored in the memory 132 and executes various types of processes. Under the control of the CPU 131, the memory 132 stores the stated computer programs, various types of data obtained during printing processes, and so on, and is, for example, a flash memory (Flash ROM), an HDD, or the like. The communication interface 133 is, for example, an interface that exchanges image data and the like with a host computer, whereas the user interface 134 is an interface that exchanges message data and the like with the operation panel 12.

The printer controller 13 has, as a functional configuration, a storage unit 31, a resource data table creation unit 32, a receiving unit 33, a first obtainment unit 34, a second obtainment unit 35, and a display unit 36, as shown in FIG. 2. Note that the storage unit 31 can be realized using, for example, the memory 132; meanwhile, the various elements such as the resource data table creation unit 32 can be realized primarily by, for example, the CPU 131 executing computer programs stored in the memory 132 and controlling the various pieces of hardware.

The storage unit 31 stores computer programs for executing various types of processes, a color conversion table for converting image data into print data, config data (a config data table), and multiple pieces of resource data implemented as packages (resource data packages). The storage unit 31 can store the config data of resource data packages, resource data packages themselves, and so on in predetermined locations (addresses) in the Flash ROM (flash memory).

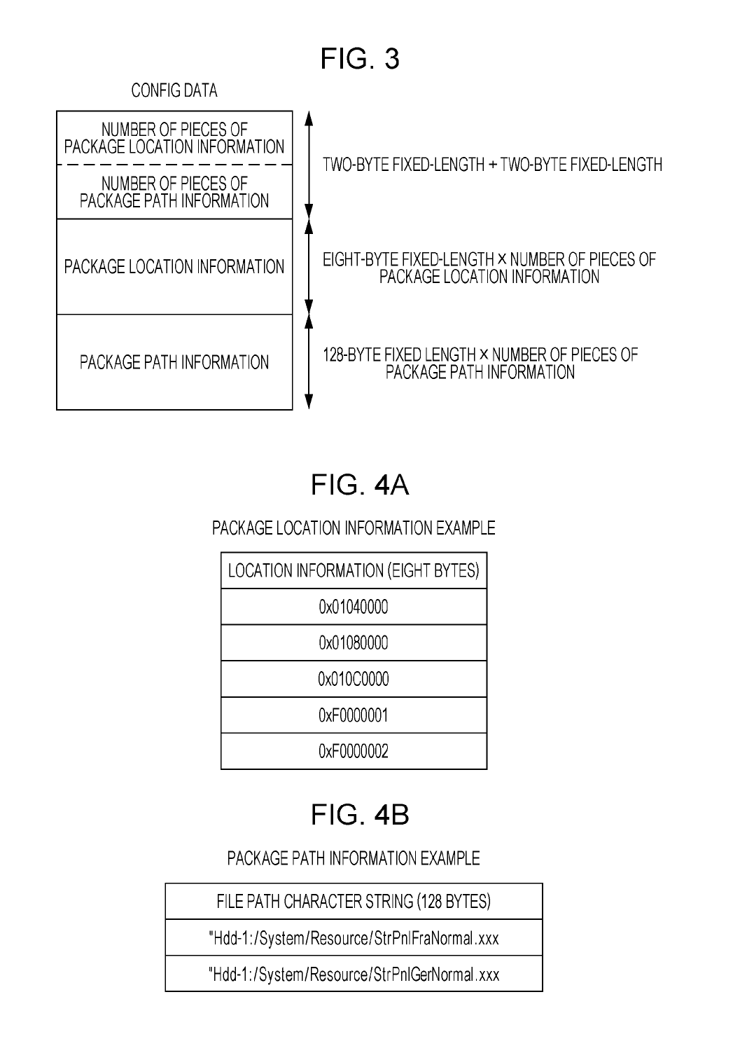

Next, the data structure of the config data will be described with reference to FIGS. 3 to 4B. The config data is data that has information of the location within the Flash ROM (that is, starting address information) where resource data packages that have been packaged in a predetermined format are stored. Note that in the case where the resource data packages are not located in the Flash ROM and are instead provided as resource files within a storage device such as an HDD, the config data is data having path information instead of the location information. For example, the config data is configured so as to have, as shown in FIG. 3, a number of pieces of package location information, a number of pieces of package path information, the package location information, and the package path information. The number of pieces of package location information is the same number as there are packages stored in the Flash ROM, and this information can be realized as two-byte fixed-length data. Meanwhile, the number of pieces of package path information is the number of packages stored in the storage device, and this information can also be realized as two-byte fixed-length data. In the case where the location information of a single package is realized as eight-byte fixed-length data, the package location information has a data amount equivalent to eight-byte fixed-length data multiplied by the number of pieces of package location information. Likewise, in the case where the path information of a single package is realized as 128-byte fixed-length data, the package path information has a data amount equivalent to 128-byte fixed-length data multiplied by the number of pieces of package path information.

FIGS. 4A and 4B are diagrams illustrating specific examples of package location information and path information. FIG. 4A illustrates an example of the package location information, and is configured of the address information (for example, eight bytes) of each of the packages. FIG. 4B, meanwhile, illustrates an example of the package path information, and is configured of the file path character strings (for example, 128 bytes) contained in each of the packages. Note that in the package location information, address information that starts with, for example, “0x01” can be determined to be an address in the Flash ROM, whereas address information that starts with, for example, “0xFO” can be determined to be a path information index.

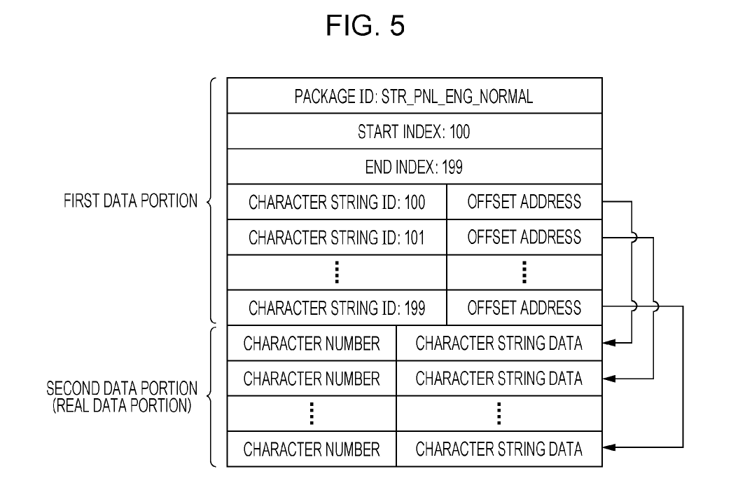

Next, the data structure of the resource data package will be described with reference to FIG. 5. The resource data package stores resource data sets, which are the units of management, in association with package IDs; as shown in FIG. 5, the resource data package contains a first data portion having a package ID (PID), a start index, an end index, a character string ID (data ID), and location information of character string data (real data) associated with a corresponding character string ID, and a second data portion (real data portion) having a number of characters of each piece of character string data and the character string data. The package ID is an ID unique to the packaged resource data. The start index and end index are information related to the number of character string IDs contained in the package. The character string ID is an identifier for associating the location information of the character string data. The location information of the character string data is a relative offset address within the package, or in other words, from the start address of the package. The number of characters of the character string data indicates the data amount of the character string data, and is, for example, four-byte fixed-length data; the character string data, meanwhile, is data related to a character string that is actually displayed in the operation panel 12.

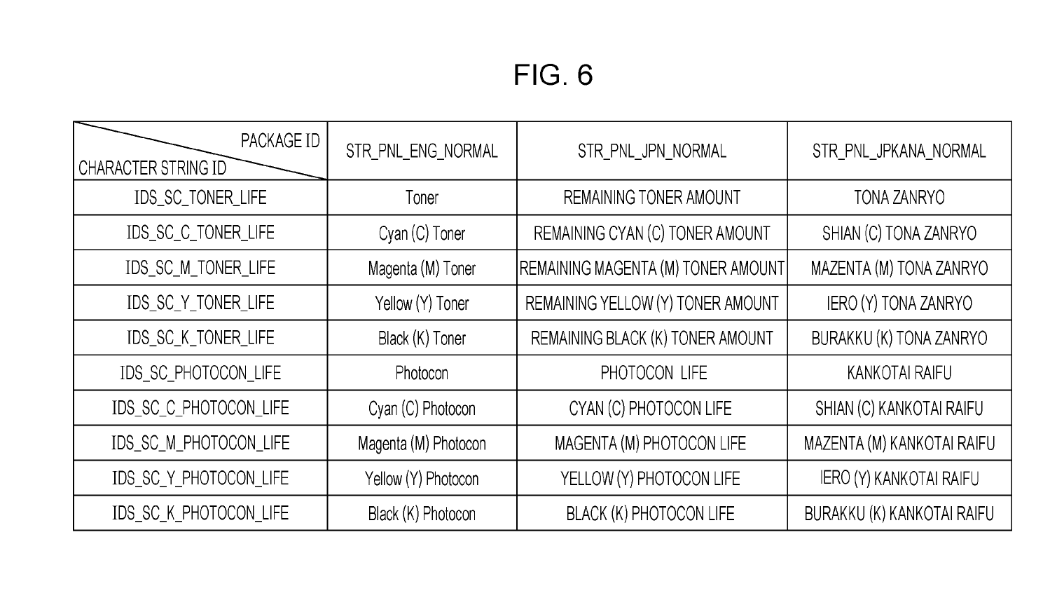

An example of the character string data is shown in FIG. 6. FIG. 6 illustrates character string data, expressing various messages in multiple languages, in a table. In this case, the character string data (resource data) for each message displayed in the operation panel 12 can be packaged as a single unit for each language (English, Japanese, Japanese kana).

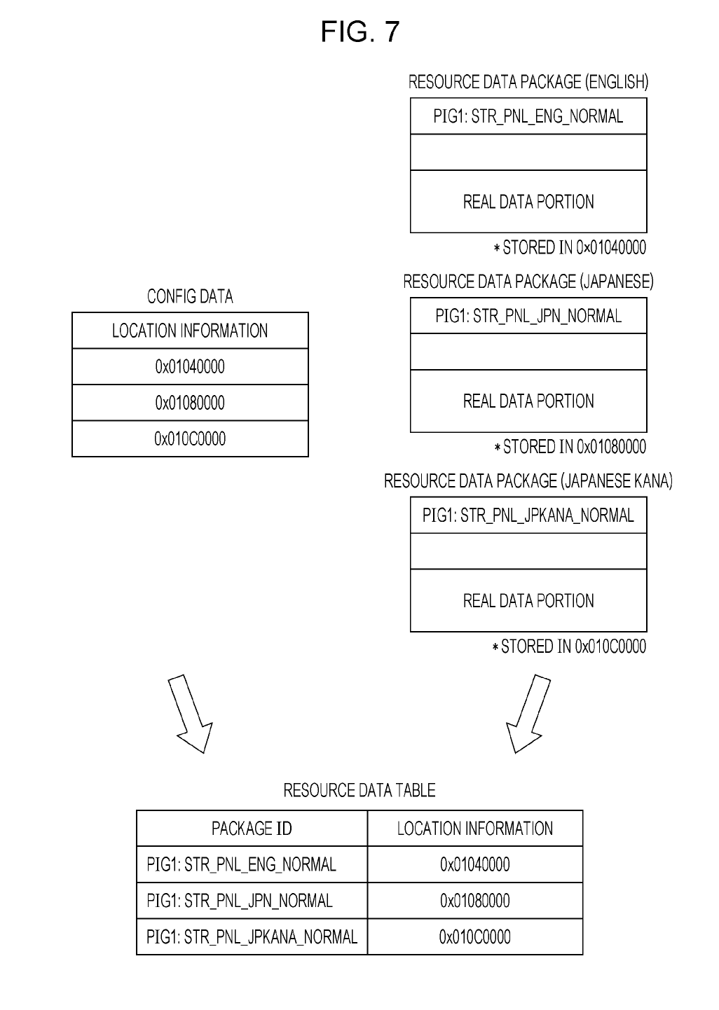

The resource data table creation unit 32 creates a resource data table in which package IDs and resource data package location information are associated with each other. In other words, the resource data table creation unit 32 can create the resource data table by referring to the config data and obtaining the number of packages and the location information of each package from the storage unit 31, and furthermore referring to each resource data package from the obtained location information and obtaining the package IDs of those resource data packages from the storage unit 31. An example of a created resource data table is illustrated in FIG. 7. Here, the timing at which the resource data table creation unit 32 creates the resource data table can be set to, for example, when the receiving unit 33 receives a specific package ID and a specific character string ID (mentioned later), or when a resource data package stored in the storage unit 31 is updated, or when the printer apparatus 10 is turned on.

The receiving unit 33 receives a specific package ID and a specific character string ID (data ID). The specific package ID and the specific character string ID are pieces of information inputted by the user through the operation panel 12, and specifically are a package ID and a character string ID corresponding to a specified language and a character string to be displayed.

The first obtainment unit 34 refers to the resource data table created by the resource data table creation unit 32 and obtains the location information of the resource data package corresponding to the specific package ID received by the receiving unit 33. In other words, the first obtainment unit 34 functions as a resource management unit.

The second obtainment unit 35 accesses the resource data package corresponding to the specific package ID stored in the storage unit 31 based on the location information of the resource data package obtained by the first obtainment unit 34, and obtains the corresponding character string data from the character string data location information associated with the specific data ID. In other words, the second obtainment unit 35 functions as a character string data processing unit.

The display unit 36 displays the character string data obtained by the second obtainment unit 35 in the liquid-crystal display of the operation panel 12 or the like.

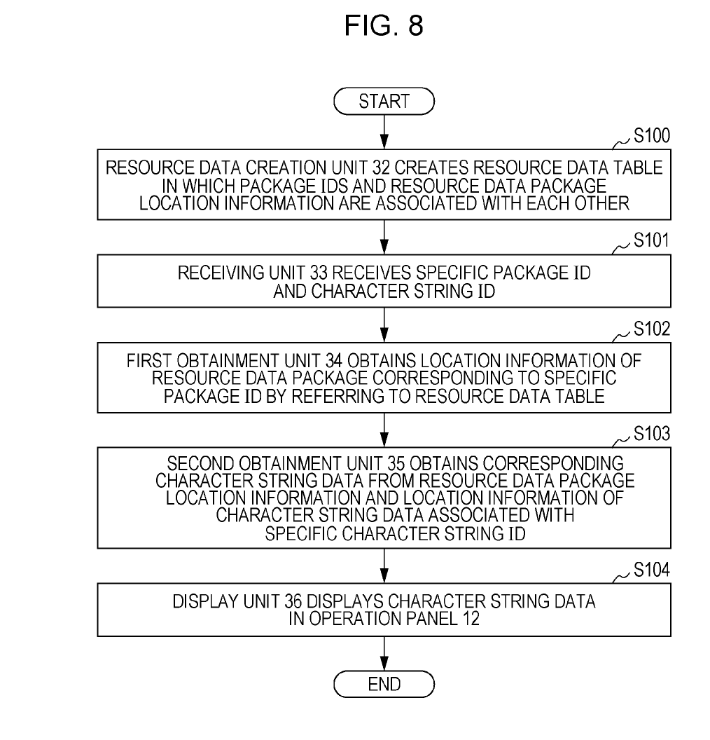

Hereinafter, a resource data management method executed by the printer apparatus 10 will be described with reference to the flowchart illustrated in FIG. 8. Note that it is assumed that a process serving as a previous step to the creation of the resource data table, where, for example, three pieces of packaged resource data (packages) and config data as shown in FIG. 7 are stored in advance in the storage unit 31, has been carried out. Note also that the character string ID and character string data in each piece of resource data are those shown in the table illustrated in FIG. 6. Furthermore, each step (including partial steps to which reference numerals are not assigned) can be rearranged in any desired order or executed in parallel as long as doing so does not cause conflict in the processing content.

First, the resource data table creation unit 32 creates the resource data table in which the package IDs (PIDs) and resource data package location information are associated with each other (step S100). In other words, the resource data table creation unit 32 can create the resource data table by referring to the config data and obtaining the number of packages and the location information of each package from the storage unit 31, and furthermore referring to each resource data package from the obtained location information and obtaining the package IDs of those resource data packages from the storage unit 31. The timing at which the resource data table creation unit 32 creates the resource data table can be set to, for example, when the receiving unit 33 receives a specific package ID and a specific character string ID (mentioned later), or when a resource data package stored in the storage unit 31 is updated, or when the printer apparatus 10 is turned on.

Next, the receiving unit 33 receives the specific package ID and the specific character string ID (data ID) (step S101). The specific package ID and the specific character string ID are pieces of information inputted by the user through the operation panel 12, and specifically are a package ID and a character string ID corresponding to a specified language and a character string to be displayed. For example, when an operation for displaying a message reading “remaining toner amount” in the language “Japanese” is received through the operation panel 12, the receiving unit 33 receives the input of a specific package ID “STR_PNL_JPN_NORMAL” and a specific character string ID “IDS_SC_TONER_LIFE” corresponding to the stated language and message.

Next, the first obtainment unit 34 refers to the resource data table created by the resource data table creation unit 32 and obtains the location information of the resource data package corresponding to the specific package ID received by the receiving unit 33 (step S102). For example, in the case where the input of the specific package ID “STR_PNL_JPN_NORMAL” has been received, the first obtainment unit 34 refers to the resource data table illustrated in FIG. 7 and obtains the corresponding location information “0x01080000”.

Next, the second obtainment unit 35 accesses the resource data package corresponding to the specific package ID stored in the storage unit 31 based on the location information of the resource data package obtained by the first obtainment unit 34, and obtains the corresponding character string data from the character string data location information associated with the specific character string ID (step S103). For example, the second obtainment unit 35 accesses the Flash ROM based on the location information “0x01080000” and obtains, from the corresponding Japanese package, the character string data “remaining toner amount” associated with the specific character string ID “IDS_SC_TONER_LIFE”.

Next, the display unit 36 displays the real data obtained by the second obtainment unit 35 in the liquid-crystal display of the operation panel 12 or the like (step S104). For example, the display unit 36 displays the aforementioned obtained character string data “remaining toner amount” in the liquid-crystal display.

As described thus far, according to the printer apparatus (resource data management apparatus) and the resource data management method of this embodiment, the resource data can be managed in package units when the character string data is updated, even in the case where, for example, character string data has been replaced, character string data of a new language has been added, or the like. As a result, the effort and cost involved when a designer resets the resource data packages can be eliminated, which makes it possible to update the resource data in a flexible manner. In other words, in this embodiment, although the number of packages and the location information thereof can be understood from the config data, the real data within the packages cannot be understood, and furthermore, the address information of packaged resource data cannot be understood from that resource data. By employing such a configuration, it is acceptable to amend only the number of pieces of packaged resource data (the number of packages) and the address information in the config data when the resource data is to be added/deleted in package units.

In addition, the character string data can be read out based on the latest updated resource data packages in the storage unit 31 by referring to the resource data table created by the resource data table creation unit 32 rather than the resource data table set as a default. Here, by setting the timing at which the resource data table creation unit 32 creates the resource data table to, for example, when the receiving unit 33 receives the specific package ID and the specific character string ID, or when a resource data stored in the storage unit 31 is updated, or when the printer apparatus 10 is turned on, the latest resource data table can be created and used when the printer apparatus 10 is used.

### Variations

Although an exemplary embodiment of the invention has been described thus far, the invention is not intended to be limited to the aforementioned embodiment; many variations, additions, and omissions can be made by those skilled in the art without departing from the essential spirit and scope expressed by the aspects of the invention.

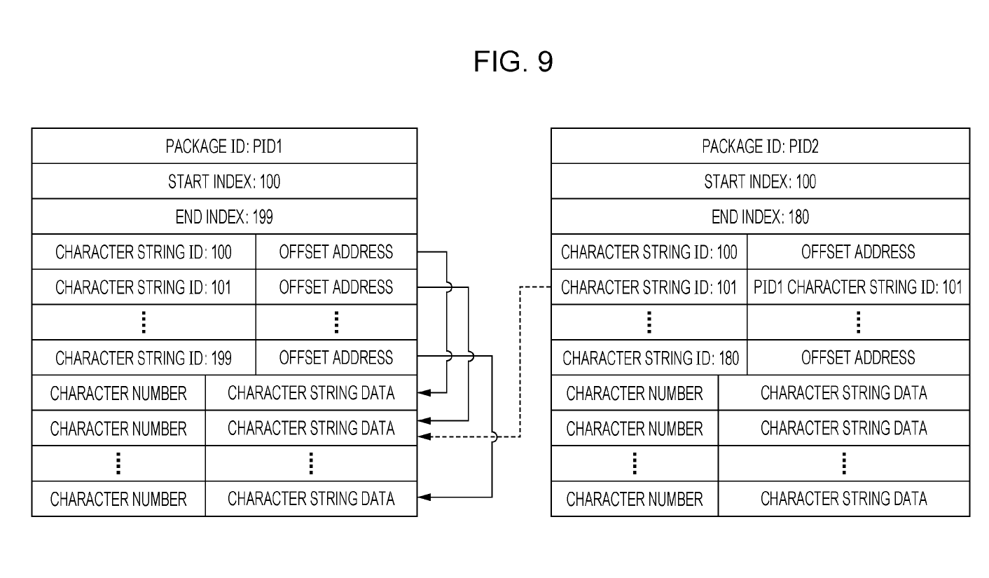

For example, the resource data in the embodiment can be configured so as to have two types of packages, or a first type resource data package in which the character string data location information associated with the character string ID (data ID) indicates only the character string data location information contained within that resource data, and a second type resource data package in which at least one piece of location information from the character string data location information associated with the character string ID indicates location information within the character string data contained in another piece of resource data. In this case, to use an example of two packages, or a first type resource data package (having a package ID of “PID1”) and a second type resource data package (having a package ID of “PID2”), as shown in FIG. 9, when a given piece of character string data is shared, the location information associated with the corresponding character string ID in the second type resource data package can be assigned the package ID “PID1” and the character string ID “character string ID: 101” of the first type resource data package.

As a result, it is not necessary to hold character string data that is shared by each language in the resource data of each individual language, and it is instead acceptable to hold only the difference data; therefore, it is possible to suppress the data amounts of the resource data groups stored in the storage unit 31.

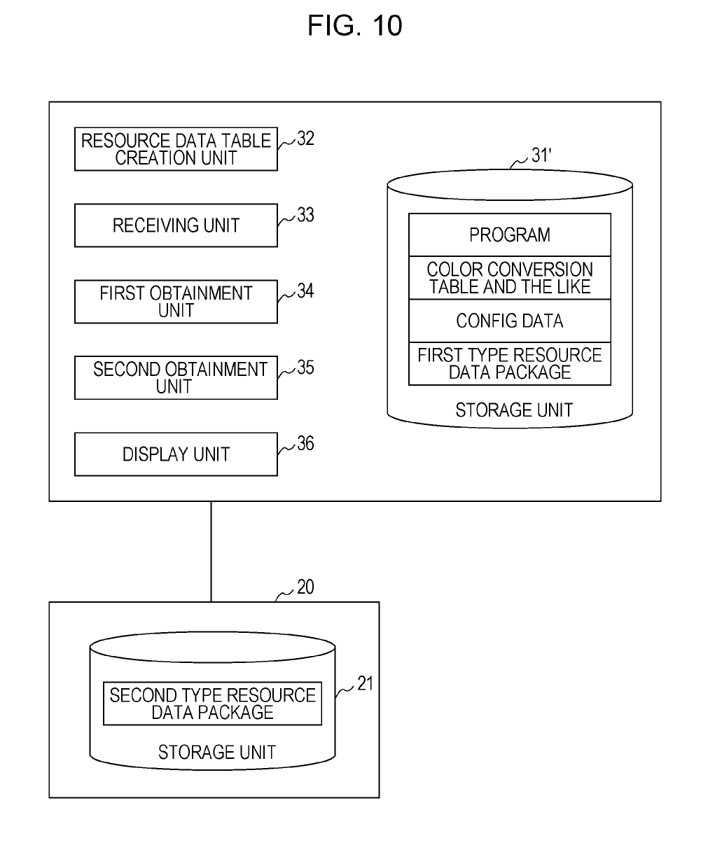

Furthermore, although the aforementioned embodiment describes an example in which the resource data packages are stored in a memory or the like installed within the printer apparatus 10, the invention is not limited thereto; for example, as shown in FIG. 10, the resource data packages may be provided in a storage unit 21 of a removable storage medium (for example, a USB memory or the like) 20. In this case, the default resource data package can be stored in the storage unit 31′ of the printer apparatus 10, whereas the added resource data package can be stored in the storage unit 21 installed within the removable storage medium.

Further still, although the aforementioned embodiment describes an example of character string data, the invention is not limited thereto, and the invention can also be applied with, for example, font data, icon data, and help guidance display data. Although the character string data serving as resource data is configured so as to contain mainly the character string ID, the location information associated with the character string ID, the number of characters, and the character string data, in the case where font data is used, the data is configured so as to contain a language-specific character code, location information associated with that character code, width/length information, and bitmap data. Meanwhile, in the case of icon data, the data is configured so as to contain an icon ID, location information associated with the icon ID, width/length information, and bitmap data. Furthermore, in the case of help guidance display data, the data is configured so as to contain combined data including character string data and icon data.

Furthermore, although the aforementioned embodiment describes an example in which a printer apparatus serves as the resource data management apparatus, the invention is not limited thereto, and can be applied in various apparatuses that require the ability to switch between multiple language displays; the invention can therefore also be applied in, for example, complex machines, digital cameras, and other such apparatuses.

Furthermore, although the resource data management apparatus 10 in the aforementioned embodiment is provided with elements in accordance with the application of the apparatus, some of the elements provided in the resource data management apparatus 10 may be configured as a single unit, or the single unit may be divided into multiple units.

Finally, although the aforementioned embodiment describes the resource data management apparatus 10 as being configured so as to include elements that have respective corresponding processing functions, the invention is not limited thereto, and the configuration may instead be such that the elements are located on a network or in another device that is communicably connected to the resource data management apparatus 10.

The entire disclosure of Japanese Patent Application No. 2010-091501, filed Apr. 12, 2010 is expressly incorporated by reference herein.

What is claimed is:

1. A resource data management apparatus comprising:
at least one resource data package that is associated with a package ID and that stores a resource data set, the resource data set serving as a unit of management;
a config data table that stores location information of each resource data package; and
a resource data table creation unit that creates a resource data table storing the package ID and the location information of the resource data package, by referring to the resource data package and the config data table.

2. The resource data management apparatus according to claim 1, wherein the resource data set includes one or more data IDs and real data corresponding to the one or more data IDs.

3. The resource data management apparatus according to claim 2, further comprising:
a receiving unit that receives a specific package ID and a specific data ID;
a first obtainment unit that obtains location information of a resource data package corresponding to the specific package ID by referring to the created resource data table;
a second obtainment unit that obtains real data corresponding to the specific data ID by referring to the resource data package corresponding to the specific package ID based on the obtained location information of the resource data package; and
a display unit that displays the obtained real data.

4. The resource data management apparatus according to claim 3,
wherein the resource data set further includes location information within a package of real data associated with the data ID; and
the second obtainment unit obtains real data corresponding to the location information within the package of the real data associated with the specific data ID by referring to the resource data package corresponding to the specific package ID based on the obtained location information of the resource data package.

5. The resource data management apparatus according to claim 2, wherein the resource data table creation unit creates the resource data table when the receiving unit has received the specific package ID and the specific data ID.

6. The resource data management apparatus according to claim 1, wherein the resource data table creation unit creates the resource data table when the resource data package has been updated or when the apparatus has been turned on.

7. The resource data management apparatus according to claim 2, wherein the resource data package includes one or more data IDs and location information of real data associated with the one or more data IDs, and furthermore stores a second type resource data in which at least one piece of location information from among the pieces of location information of the real data associated with the one or more data IDs indicates location information of real data included in another resource data package.

8. The resource data management apparatus according to claim 1, wherein the resource data package is stored in a storage device installed in the apparatus itself or in a storage medium that can be attached to/removed from the apparatus itself.

9. The resource data management apparatus according to claim 1, wherein the resource data set is configured of at least one of a character string data set, a font data set, an icon data set, and a help guidance data set used in an image forming apparatus.

10. A resource data management method comprising:
storing at least one resource data package that holds a resource data set serving as a unit of management in association with a package ID, and a config data table that holds location information of each of the resource data packages; and
creating a resource data table storing the package ID and the location information of the resource data package by referring to the resource data package and the config data table.
